(19) United States
(12) Patent Application Publication
(10) Pub. No.: US 2021/0294059 A1
(43) Pub. Date: Sep. 23, 2021

(54) FIBER TROUGH SYSTEM; FITTING FOR USE IN FIBER TROUGH SYSTEM; AND METHOD OF ROUTING CABLE

(71) Applicant: COMMSCOPE TECHNOLOGIES LLC, Hickory, NC (US)

(72) Inventors: Scott Jean ANDERSON, Burnsville, MN (US); Ruben ARVILLA, Cd. Juarez (MX); Victor Hugo FLORES, Cd. Juarez (MX); Patrick James THOMPSON, Prior Lake, MN (US)

(21) Appl. No.: 17/338,171

(22) Filed: Jun. 3, 2021

Related U.S. Application Data
(63) Continuation of application No. PCT/US2019/064204, filed on Dec. 3, 2019.
(60) Provisional application No. 62/774,633, filed on Dec. 3, 2018.

(51) Int. Cl. G02B 6/44

(52) U.S. Cl. CPC G02B 6/4459

(57) ABSTRACT

A fitting for use with a fiber trough system includes first and second opposing end walls and a first side wall extending between the first and second end walls. The first side wall has opposite free ends defining a height of the first side wall that is greater than the height of the first and second end walls. The fitting can also have a second side wall opposing the first side wall and extending between the first and second end walls to result in a closed perimeter shape with an open passageway therethrough. The fitting can be used as part of a fiber management system.

### CROSS-REFERENCE TO RELATED APPLICATION

This application is a Continuation of PCT/US2019/064204, filed on Dec. 3, 2019, which claims the benefit of U.S. patent application Ser. No. 62/774,633, filed on Dec. 3, 2018, the disclosures of which are incorporated herein by reference in their entireties. To the extent appropriate, a claim of priority is made to each of the above disclosed applications.

### TECHNICAL FIELD

This disclosure relates to a system for the management and routing of cables, such as telecommunications cables. More particularly, this disclosure relates to fittings used with troughs and the routing of a fiber optic cable relative to equipment.

### BACKGROUND

In the telecommunications industry, optical fibers are used for signal transmissions. The optical fibers need to be organized and managed.

For example, optical fiber cables need to be routed from fiber distribution equipment and optical line terminating equipment. In some cases, the cable routing can take place in concealed ceiling areas or in another manner to route cables from one location to the other.

When routing optical fiber cables, it is desirable that a routing system is easy to assemble, readily accessible, and adaptable to changes in equipment needs. Improvements are desirable.

### SUMMARY

In one aspect, a fitting for use with a fiber trough system to route cables is provided. The fitting includes first and second opposing end walls and a first side wall. The first side wall extends between the first and second end walls. The first side wall has opposite free ends defining a height of the first side wall that is greater than the height of the first and second end walls.

The first and second end walls may be equal in height, and each end wall can have opposite free ends and an outwardly extending radiussed lip adjacent to a first of the free ends. The first side wall can have a curved section having a common boundary with the radiussed lip of the first and second end walls.

In example embodiments, the first side wall includes an extended section extending from the curved section and ending with a first of the free ends of the first side wall.

The extended section defines opposite side edges. Each of the side edges can have an inwardly extending radiussed portion.

In many example embodiments, the fitting further includes at least two retention tabs projecting from the first side wall in a direction away from the first and second end walls.

In example embodiments that include retention tabs, the retention tabs can project perpendicular from the first side wall.

In example embodiments, the fitting further includes a second side wall opposing the first side wall and extending between the first and second end walls to result in a closed perimeter shape with an open passageway therethrough.

In some examples, the second side wall has opposite free ends can be straight between the opposite free ends.

The second side wall can have a height that is greater than the height of the first and second end walls and less than the height of the first side wall, in some embodiments.

In example embodiments, the fitting can further include a latch arrangement projecting from one of the first and second end walls or first side wall to permit releasable securement of the fitting to a trough.

In another aspect, a fiber trough system for cable management is provided. The fiber trough system includes a cable trough having a base and opposing sides projecting from the base. The trough is sized to permit a plurality of cables to be routed along the base. The trough includes at least one aperture extending through the base. A fitting, as variously characterized above, is within the at least one aperture. The cables can be routed from the base and through the fitting.

In some embodiments, the cable trough has a plurality of spaced apertures extending through the base. Each of the apertures includes a fitting as variously characterized above.

In some systems, the trough includes at least one opening in one of the sides. A T-fitting is located within the opening in the side.

In some systems, the cable trough includes a plurality of cable troughs secured together with couplers, each of the cable troughs having a base and opposing sides projecting from the base. At least some of the bases of the troughs include one or more apertures extending therethrough. A fitting, as variously characterized above, is positioned within the apertures in the base. A plurality of cable guides are positioned below the cable troughs. The cable guides are positioned below and in axial alignment with the fittings in the apertures in the base.

In some example embodiments, the system further includes openings in the sides of the troughs. A T-fitting can be positioned within the openings in the sides. A plurality of racks are positioned between cable guides and below the cable troughs. At least some of the racks are positioned below and in axial alignment with the T-fittings in the sides.

In another aspect, a method of routing cable is provided. The method includes laying a plurality of cables along a trough having a base and opposing sides projecting from the base. The method further includes routing the cables through the fitting, as variously characterized above, seated within a hole in the base.

A variety of examples of desirable product features or methods are set forth in the description that follows, and in part, will be apparent from the description, or may be learned by practicing various aspects of this disclosure. The aspects of this disclosure may relate to individual features, as well as combinations of features. It is to be understood that both the foregoing general description and the following detailed description are explanatory only, and are not restrictive of the claimed inventions.

### BRIEF DESCRIPTION OF THE DRAWINGS

FIG. 1 is a perspective view of a first embodiment of a fitting for use with a fiber trough system, constructed in accordance with principles of this disclosure;

FIG. 2 is another perspective view of the fitting of FIG. 1;

FIG. 3 is a top plan view of the fitting of FIGS. 1 and 2;

FIG. 4 is a rear view of the fitting of FIGS. 1 and 2;

FIG. 5 is a perspective view of a cable trough used in a fiber management system, the trough having apertures for receiving the fitting of FIGS. 1-4;

FIG. 6 is a perspective view showing the fitting of FIGS. 1-4 positioned within one of the apertures in the trough of FIG. 5;

FIG. 7 is a rear view of an alternate embodiment of the fitting of FIGS. 1-4, and depicting a latch arrangement that can be used to secure the fitting of FIGS. 1-4 in place within the aperture of the trough of FIG. 5;

FIG. 8 is a schematic view of one embodiment of a fiber trough system used with equipment;

FIG. 9 is a schematic view of a second embodiment of a fiber trough system, similar to that shown in FIG. 8, and showing a variation in the dimension of the racks;

FIG. 10 is a perspective view of a cable trough that can be used with the systems of FIGS. 8 and 9, and showing apertures in the base of the trough and openings in one of the sides of the trough;

FIG. 11 is a perspective view of a T-shaped fitting that can be used in the openings of the sides of the trough of FIG. 10 and with the systems of FIGS. 8 and 9; and

FIG. 12 is another perspective view of the T-fitting of FIG. 11 and positioned within an opening in the side of the trough.

### DETAILED DESCRIPTION

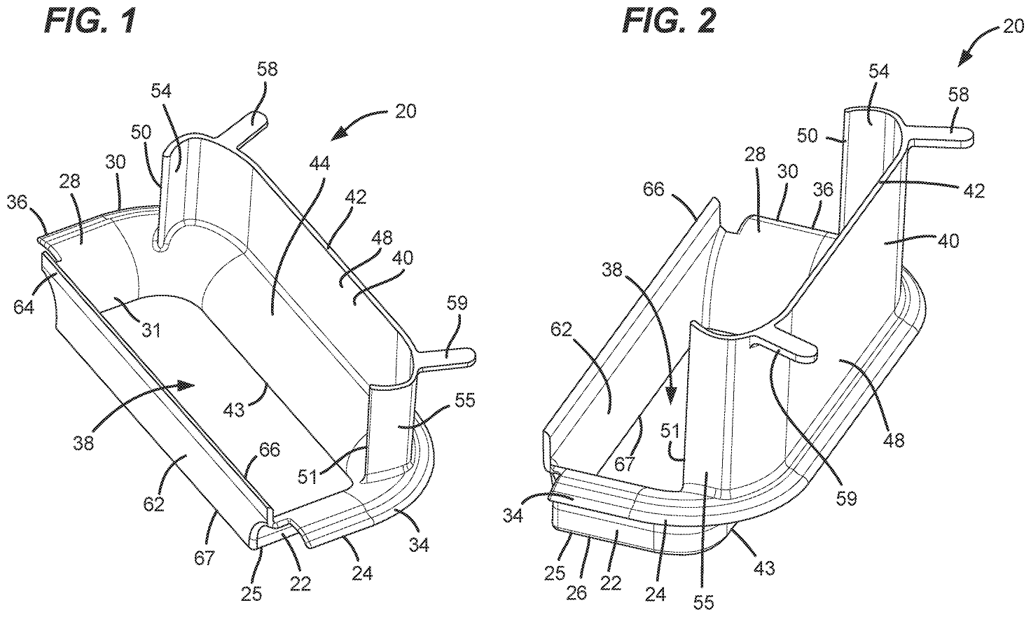

This disclosure relates to a fitting for use with a fiber trough system, as well as the related fiber trough system and methods for routing cable, and presents improvements over the prior art. Various examples of the components and configurations are illustrated in FIGS. 1-12. It should be understood that numerous other components and configurations are possible.

Referring now to FIGS. 1-4, a first embodiment of a fitting for use with a fiber trough system is shown at 20. The fitting 20 can be positioned within an aperture in a fiber trough as described further below, and used to route cables from the trough and through the fitting 20.

The fitting 20 of FIGS. 1-4 includes a first end wall 22. The first end wall 22 has first and second opposite terminal or free ends 24, 25. In use, the free end 25 corresponds to a bottom rim 26 of the fitting 20. An axial length between the free end 24 and free end 25 defines a height of the first end wall 22.

The fitting 20 further includes a second end wall 28. The second end wall 28 is opposing the first end wall 22. The second end wall 28 has opposite free ends 30, 31. An axial distance between the free end 30 and free end 31 defines the height of the second end wall 28. In use, when the fitting 20 is positioned within an aperture of a trough, the free end 31 corresponds to the bottom rim 26 of the fitting 20.

The fitting 20 is used to route cables, such as optical fiber cables. As such, it is helpful for the fitting 20 to avoid having sharp corners or in any way contribute to causing sharp turns in the optical fiber cables, as this could lead to the loss of signals. The fitting 20, in this embodiment, has features to advantageously contribute to the avoidance of sharp corners. For example, the free end 24 of the first end wall 22 and the free end 30 of the second end wall 28 each has an outwardly extending radiussed lip 34, 36 adjacent to the free ends 24, 30. By the term “outwardly extending” it is meant that the free end 24 and free end 30 are radially spaced away from a remaining portion of their respective end walls 22, 28 and away from the rest of the fitting 20. The radiussed lips 34, 36 provide a smooth, contoured surface from the free ends 24, 30 in a direction toward the rest of the fitting 20. As such, cables outside of the fitting 20 can be directed to an interior open passage 38 from outside of the fitting 20 by extending over at least one of the radiussed lips 34, 36 and into the open passageway 38.

The fitting 20 further includes a first side wall 40. The first side wall 40 extends between the first and second end walls 22, 28. The first side wall 40 has opposite terminal or free ends 42, 43. A height of the first side wall 40 is defined as a length between the free end 42 and free end 43. The height of the first side wall 40 is greater than the height of the first and second end walls 22, 28. In the example shown, the height of the first side wall 40 is at least twice the height of the first end wall 22 and second end wall 28. When the fitting 20 is in use, the free end 43 of the first side wall 40 forms part of the bottom rim 26 of the fitting 20.

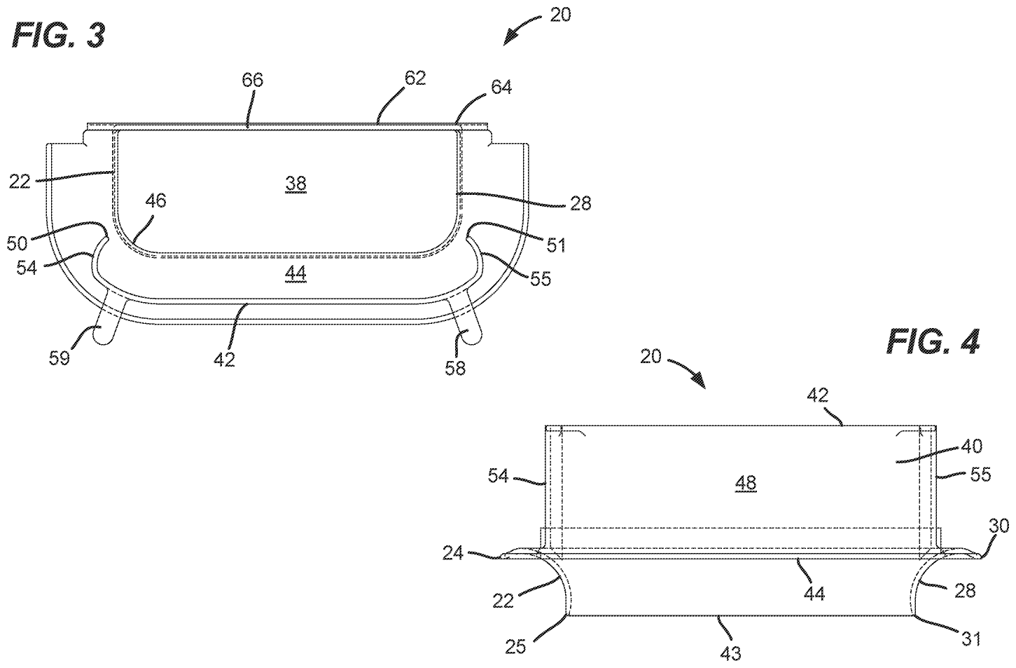

The fitting 20 can be shaped so that it is received within an appropriately sized aperture in a fiber trough, with the free ends 24, 30 resting on the fiber trough 30. In addition, the first side wall 40 can have a portion that also rests on top of the fiber trough. In particular, the first side wall 40 can include a curved section 44 that is coterminous with, or has a common boundary with, the radiussed lips 34, 36 of the first and second end walls 22, 28. The curved section 44, preferably, is on the same radius of curvature as the radiussed lips 34, 36 so that a continuous, contoured inner surface 46 (FIG. 3) is formed.

The first side wall 40 further includes an extended section 48. The extended section 48 extends from the curved section 44 and ends at a terminal end at the free end 42. As can be seen in FIGS. 1-4, the extended section 48 has a length that extends completely between the first end wall 22 and second end wall 28.

The extended section 48 can be used to allow for directing of cables into the passageway 38 from only a single direction, by wrapping the cables around the extended section 48, in order to have the cable enter the passageway from one selected side. As such, it is helpful for the extended section 48 to avoid sharp turns or corners. One advantageous construction includes the opposite side edges 50, 51 of the extended section 48 each having an inwardly extending radiussed portion 54, 55. In use, fiber optic cables can be wrapped around the extended section 48, and the radiussed portions 54, 55 will help to avoid sharp turns in the cable. As can be seen in FIGS. 1-3, the radiussed portions 54, 55 are inwardly extending, in that the side edges 50, 51 are turned inwardly in a direction toward the open passageway 38.

When cables are wrapped around the extended section 48, it can be helpful to have structure to keep the cables in place on the extended section 48 and prevent them from sliding off the free end 42. One such helpful structure includes at least one, and preferably two retention tabs 58, 59. The retention tabs 58, 59 project from the first side wall 40 in a direction away from the remaining part of the fitting 20, away from the open passageway 38, and away from the first and second end walls 22, 28. In the example shown in FIGS. 1-4, the retention tabs 58 project perpendicular from the first side wall 40. While the tabs 58, 59 can be located at a variety of places along the first side wall 40, in this embodiment, they extend from the extended section 48. In the example shown, the tabs 58, 59 project from the free end 42 of the first side wall 40.

In accordance with principles of this disclosure, the fitting 20 further includes a second side wall 62. The second side wall 62 opposes the first side wall 40 and extends between the first end wall 22 and second end wall 28 to result in a closed perimeter shape 64 with the open passageway 38 therethrough.

The second side wall 62 has opposite free ends 66, 67. In general, the second side wall 62 is straight and planar between the free ends 66, 67. In other embodiments, the second side wall 62 can have other shapes. In use, the free end 67 forms part of the bottom rim 26, along with the free ends 25, 31, and 43.

The second side wall 62 has a height that is defined as the length between the opposite free ends 66, 67. Many embodiments are possible. In the embodiments shown, the height of the second side wall 62 is greater than the height of the first and second end walls 22, 28 and less than the height of the first side wall 40. There can be other variations in other embodiments.

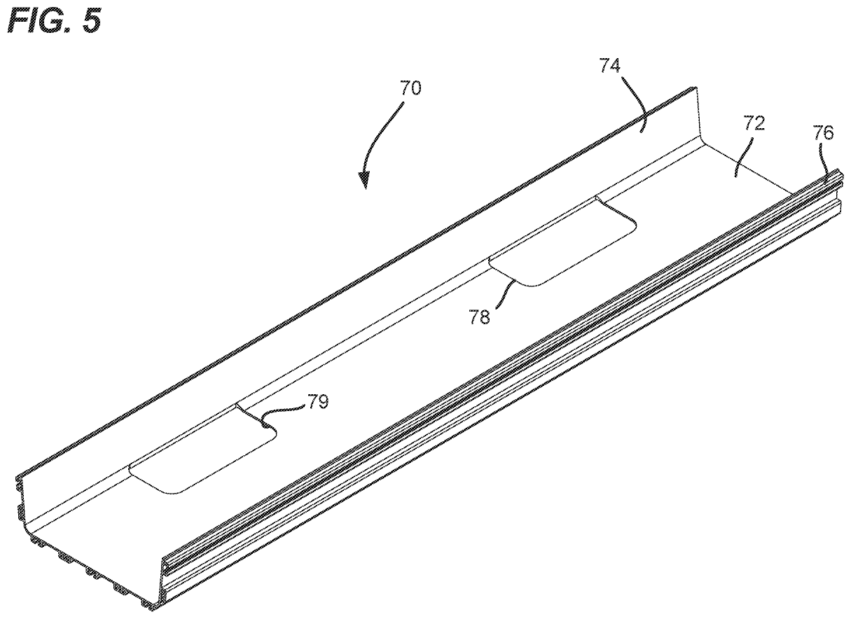

As mentioned previously, the fitting 20 is preferably used by inserting it into an aperture of a cable trough. One example cable trough is shown in FIG. 5 at 70. The trough 70 has a base 72 and opposing sides 74, 76 projecting or extending from the base 72. In general, the sides 74, 76 extend about at a 90° angle relative to the base 72, although other embodiments are possible.

The trough 70 is sized to permit a plurality of cables, such as fiber optic cables, to be routed along the base 72. The sides 74, 76 contain the cables within the trough 70 and prevent the cables from falling off of the base 72.

The trough 70 of FIG. 5 includes at least one aperture 78 extending through the base 72. In the example shown in FIG. 5, there are two apertures 78, 79. In this example embodiment, the apertures 78, 79 are not centered between the sides 74, 76; rather, the apertures 78,79 are against the side 74 and, thus, are off-center between the sides 74, 76.

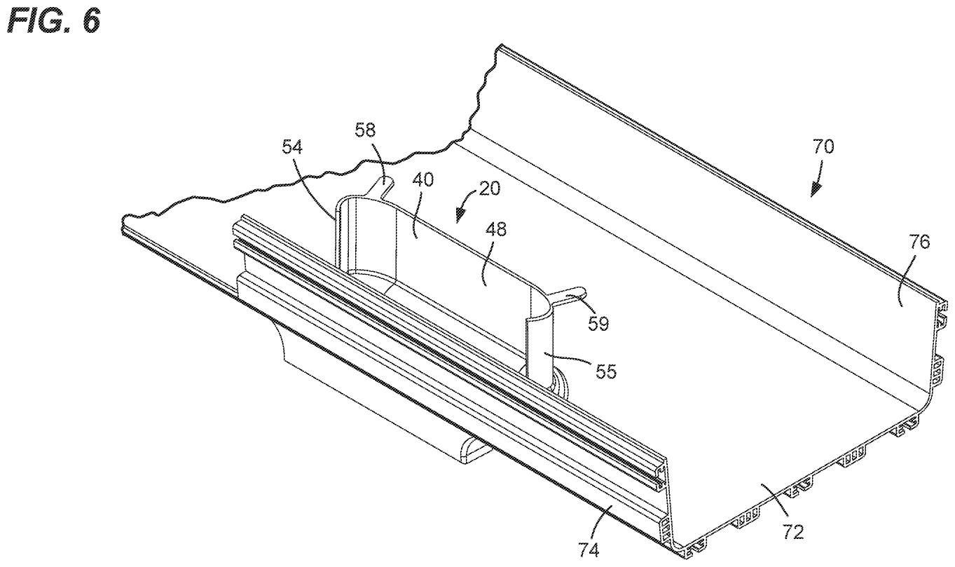

The apertures 78, 79 are sized to receive the fitting 20 therein. FIG. 6 illustrates the fitting 20 within one of the apertures 78, 79.

In this embodiment, the extended section 48 of the fitting 20 has a height greater than the sides 74, 76. Alternative arrangements are possible.

The fitting 20 is positioned within the aperture 78 such that the radiussed lips 34, 36 and curved section 44 are positioned against and rest on top of the base 72 of the trough 70.

The extended section 48 is helpful by forming a wall, or barrier, sectioning off a remaining portion of the trough 70 from the fitting 20, so that cables can bypass the fitting 20 without going over and covering up the passageway 38.

In use, cables can be routed in the trough 70, along the base 72, and then through the open passageway 38 in the fitting 20. It can be desirable to have the cables enter into the fitting 20 from only one end, at either the first end wall 22 or the second end wall 28. In that case, for cables approaching the fitting 20 from the opposite end, they can be coiled around the extended section 48 first and then routed through the open passageway 38 at the desired end wall 22 or 28.

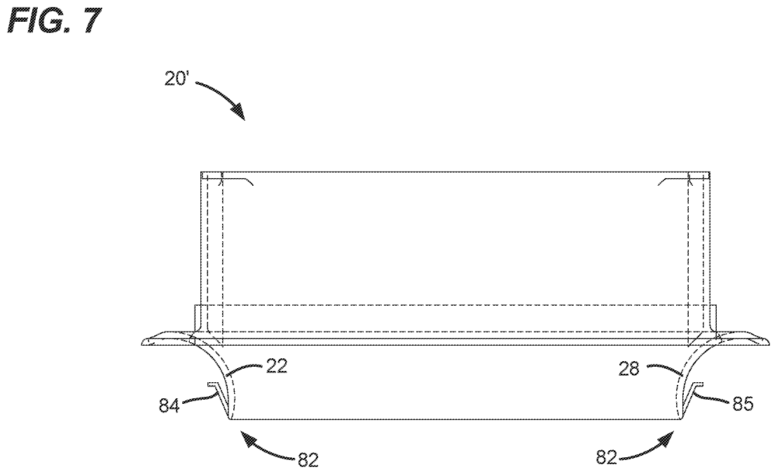

The fitting 20 can further include structure to help retain the fitting 20 within the aperture 78 and prevent unintentional removal of the fitting 20 from the aperture 78. FIG. 7 illustrates once such possibility in the alternative embodiment of the fitting shown at 20′. The fitting 20′ is generally the same structurally as the fitting 20, but it also includes a latch arrangement 82. The latch arrangement 82 will permit releasable securement of the fitting 20 within the aperture 78 to the trough 70. In this example, the latch arrangement 82 includes at least one, and as shown, 2 latch members 84, 85 in the form of flanges projecting from one of the walls of the fitting 20. In FIG. 7, the latch members 84, 85 are projecting from the end walls 22, 28. When the fitting 20 is positioned within the aperture 78, the latch members 84, 85 will deflect inwardly toward the rest of the fitting 20. After passing through the aperture 78, the latch members 84, 85 will snap back to their initial position, which would be on the opposite side of the base 72 and under the edge of the aperture 78 to help retain the fitting 20 within the aperture 78. Many alternatives are possible.

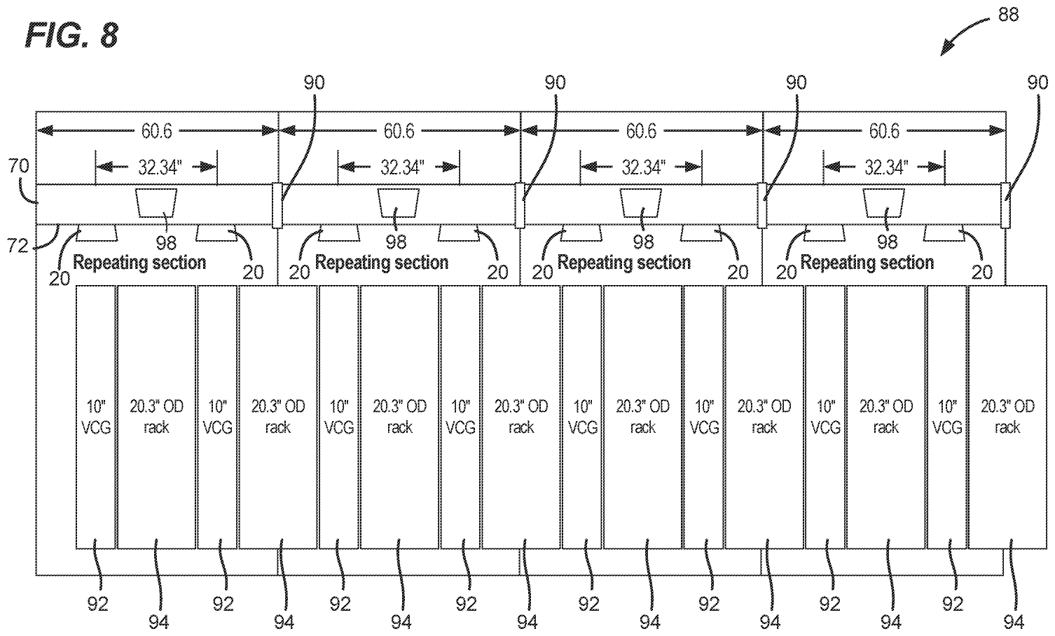

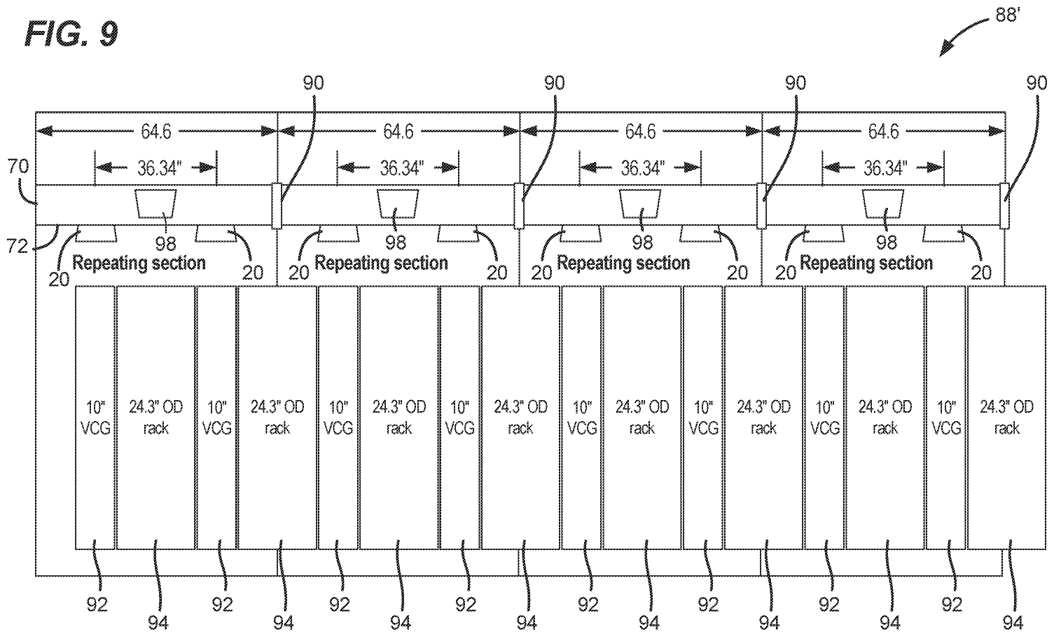

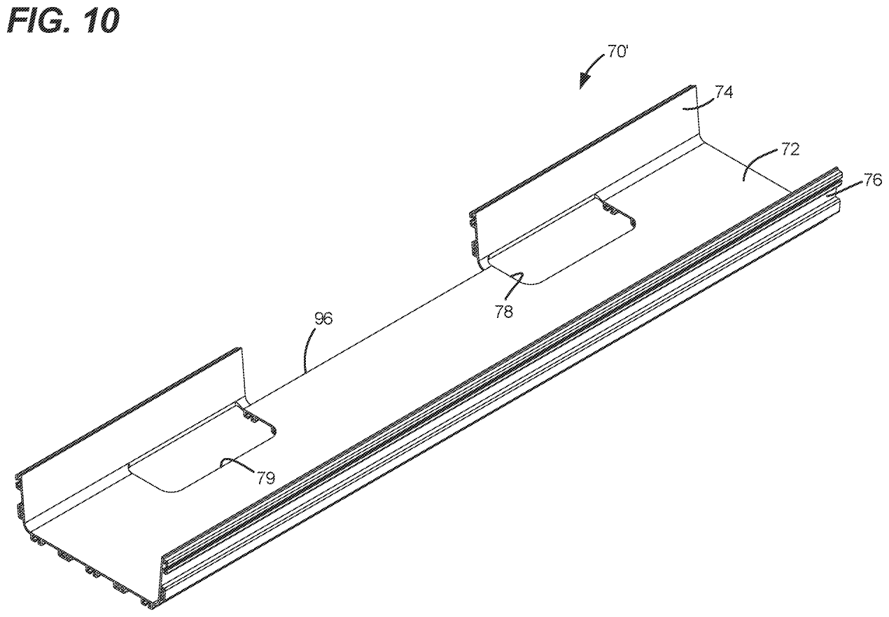

The fitting 20 can be used as part of a fiber management system. Two example fiber management systems are shown in FIGS. 8 and 9 at 88 and 88′. The system 88 will be described first, and then the variations that are shown in 88′ will be discussed after.

The system 88 shows schematically the trough 70. The trough 70 is typically made from a plurality of single troughs 70 connected by couplers 90. The couplers 90 can be the couplers as described in U.S. Pat. No. 7,093,997, incorporated herein by reference.

The system 88 can further includes a plurality of cable guides 92 positioned below the troughs 70. The cable guides 92 include further routing structure to receive cables from the troughs 70 and then route the cables to equipment. The equipment can be within a plurality of racks 94. As can be seen in FIG. 8, the cable guides 92 and racks 94 alternate with each other and are positioned below the troughs 70. The base 72 of the troughs 70 include a plurality of apertures, such as aperture 78 shown in FIG. 5. Each aperture can hold one of the fittings 20.

In the system 88, the fitting 20 (shown schematically in FIG. 8) is positioned relative to the cable guides 92 such that the cable guides 92 are positioned below and in axial alignment with one of the fittings 20. By term “axial alignment,” it is meant that a straight vertical line through the open passageway 48 in the fitting 20 will generally be centered over the cable guide 92. This arrangement is advantageous in that cables that need to be routed from the trough 70 to the equipment in the racks 94 can pass through the fitting 20 and proceed directly to the cable guide 92 below it, without having to be routed sideways or diagonal.

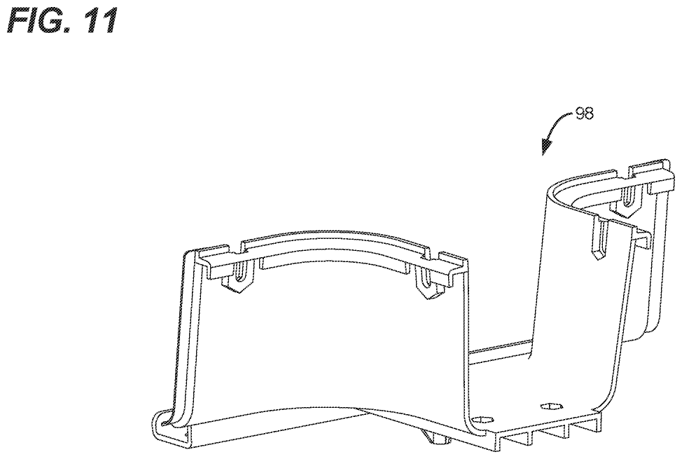

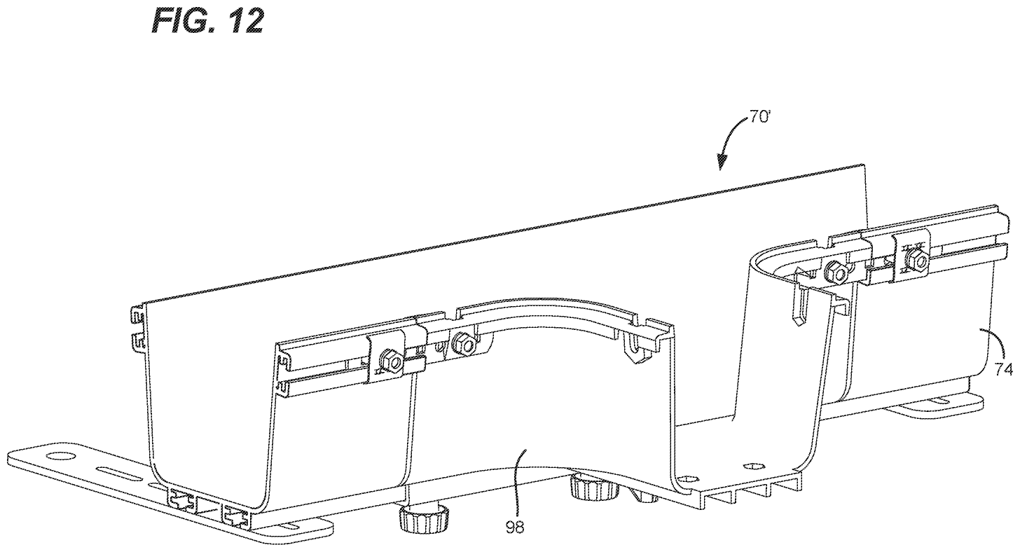

In the system 88, the troughs 70 may further include one or more openings 96 (FIG. 10) in at least one of the sides 74, 76. FIG. 10 shows a trough 70′. The trough 70′ can be the same as trough 70, except the one shown in FIG. 10 has opening 96 in the side 74. The opening 96 can be included to accommodate a T-fitting 98, as depicted in FIGS. 11 and 12.

The T-fitting 98 is shown in perspective view of FIG. 11 and positioned within opening 96 in the trough 70′ in FIG. 12. As can be appreciated from reviewing FIGS. 11 and 12, the T-fitting allows for cables to be routed from the trough 70 and through the opening 96 in the side 74.

Returning now to the system 88 of FIG. 8, the troughs 70 can have a plurality of openings 96 in one of the sides of the trough 70. In the system of FIG. 8, at least some of the racks 94 are positioned below and in axial alignment with one of the T-fittings 98. The T-fittings 98 are depicted schematically in FIG. 8.

The system 88 of FIG. 8 shows example usable dimensions. In the system 88, racks 94 that are nominal 19 inches in width, are shown to have outermost dimensions of 20.3 inches. These 19 inch racks 94 alternate with cable guides that a width of 10 inches. In such systems, it has been found convenient to have the troughs 70 include apertures 78 and side openings 96 dimensioned as illustrated. For example, the trough 70 includes an overall length of about 60.6 inches. From a center of the fitting 20 to the center of the next fitting 20 is spaced about 32.34 inches. The T-fitting 98 can be centered between the two fittings 20. The troughs 70 are connected by couplers 90. The couplers 90 will overlap each of the adjacent troughs 70, and may leave about one inch of coupler 90 between the adjacent troughs 70. When the system 88 is dimensioned with the troughs 70 as shown, it can be ensured that the cable guides 92 will remain in axial alignment and below the fittings 20.

The system 88′ in FIG. 9 is now discussed. In the system 88′, instead of the racks 94 having a nominal width of 19 inches as the system 88 of FIG. 8, the racks 94 have a nominal width of 23 inches. The outermost dimension of the 23 inch racks are 24.3 inches. In the system 88′, the each of the troughs 70 has a length of about 64.6 inches. From a center of the fitting 20 to the center of the next fitting 20 is spaced about 36.34 inches. The T-fitting 98 can be centered between the two fittings 20. The troughs 70 are connected by couplers 90. The couplers 90 will overlap each of the adjacent troughs 70, and may leave about one inch of coupler 90 between the adjacent troughs 70. This arrangement will result in ensuring that the cable guides 92 are always positioned directly below and in axial alignment with the fittings 20.

The components above can be used as part of a method of routing cable. The method includes laying a plurality of cables along trough 70, in which the trough 70 has base 72 and opposing sides 74, 76. The method can include routing the cables through the fitting 20 positioned within aperture 78 in the base 72.

In this method, the cables can then be routed directly below and in axial alignment with cable guides 92. From the cable guides 92, the cable can be routed to a rack 94. The method may also include routing cables through an opening 96 in one of the sides 74, 76 of the trough 70 and through T-fitting 98. From there, the cables can be routed to the components below, such as racks 94 or cable guides 92.

The above represents example principles. Many embodiments can be made using these principles.

1. A fitting for use with a fiber trough system; the fitting comprising:
(a) first and second opposing end walls; and
(b) a first side wall extending between the first and second end walls; the first side wall having opposite free ends defining a height of the first side wall greater than the height of the first and second end walls.

2. The fitting of claim 1 wherein:
(a) the first and second end walls are equal in height, and each end wall has opposite free ends and an outwardly extending radiussed lip adjacent a first of the free ends; and
(b) the first side wall has a curved section having a common boundary with the radiussed lips of the first and second end walls.

3. The fitting of claim 2 wherein the first side wall includes an extended section extending from the curved section and ending with a first of the free ends of the first side wall.

4. The fitting of claim 3 wherein the extended section defines opposite side edges each having an inwardly extending radiussed portion.

5. The fitting of claim 1, further comprising at least two retention tabs projecting from the first side wall in a direction away from the first and second end walls.

6. The fitting of claim 5 wherein the at least two retention tabs project perpendicular from the first side wall.

7. The fitting of claim 3 further comprising at least two retention tabs projecting from the extended section of the first side wall in a direction away from the first and second end walls.

8. The fitting of claim 7 wherein the at least two retention tabs project perpendicular from the first of the free ends of the first side wall.

9. The fitting of claim 1 further comprising a second side wall opposing the first side wall and extending between the first and second end walls to result in a closed perimeter shape with an open passageway therethrough.

10. The fitting of claim 9 wherein the second side wall has opposite free ends and is straight between the opposite free ends.

11. The fitting of claim 9 wherein the second side wall has a height greater than the height of the first and second end walls and less than the height of the first side wall.

12. The fitting of claim 1 further comprising a latch arrangement projecting from one of the first and second end walls or first side wall to permit releasable securement of the fitting to a trough.

13. The fitting of claim 1 in combination with any other claim and/or anything shown in the drawings.

14. A fiber trough system comprising:
(a) a cable trough having a base and opposing sides protecting from the base; the trough being sized to permit a plurality of cables to be routed along the base;
the trough including at least one aperture extending through the base; and
(b) a fitting of claim 1 within the at least one aperture;
wherein cables can be routed from the base and through the fitting.

15. The fiber trough system of claim 14 wherein:
(a) the cable trough has a plurality of spaced apertures extending through the base; and
(b) each of the apertures includes a fitting of claim 1 therein.

16. The fiber trough system of claim 14 wherein the trough includes at least one opening in one of the sides; and the system further comprises a T-fitting within the opening in the side.

17. The fiber trough system of claim 14 wherein:
(a) the cable trough includes a plurality of cable troughs secured together with couplers, each of the cable troughs having a base and opposing sides protecting from the base; at least some of the bases of the troughs including one or more apertures extending therethrough;
(b) a fitting including first and second opposing end walls; a first side wall extending between the first and second end walls; the first side wall having opposite free ends defining a height of the first side wall greater than the height of the first and second end walls; the fitting being within the apertures in the base; and
(c) a plurality of cable guides are positioned below the cable troughs;
wherein the cable guides are positioned below and in axial alignment with the fittings in the apertures in the base.

18. The fiber trough system of claim 17 wherein:
(a) at least some of the sides of the troughs having openings therein;
(b) a T-fitting is positioned within the openings in the sides;
(c) a plurality of racks are positioned between cable guides and below the cable troughs; and
wherein at least some of the racks are positioned below and in axial alignment with the T-fittings in the sides.

19. (canceled)

20. A method of routing cable, the method comprising:
(a) laying a plurality of cables along a trough having a base and opposing sides protecting from the base; and
(b) routing the cables through the fitting of claim 1 seated within a hole in the base.

21. (canceled)
